(19) United States
(12) Patent Application Publication
(10) Pub. No.: US 2025/0287341 A1
(43) Pub. Date: Sep. 11, 2025

(54) POSITION ESTIMATION SYSTEM

(71) Applicant: KABUSHIKI KAISHA TOSHIBA, Tokyo (JP)

(72) Inventors: Yuta HIRAI, Setagaya Tokyo (JP); Tomoko ADACHI, Kawasaki Kanagawa (JP); Koji AKITA, Yokohama Kanagawa (JP); Masaki NISHIKAWA, Yokohama Kanagawa (JP); Kentaro TANIGUCHI, Kawasaki Kanagawa (JP)

(73) Assignee: KABUSHIKI KAISHA TOSHIBA, Tokyo (JP)

(21) Appl. No.: 19/062,149

(22) Filed: Feb. 25, 2025

(30) Foreign Application Priority Data
Mar. 7, 2024 (JP) 2024-034972

(51) Int. Cl. H04W 64/00; H04B 17/318; H04W 76/15

(52) U.S. Cl. CPC H04W 64/00; H04B 17/318; H04W 76/15

(57) ABSTRACT

According to one embodiment, a position estimation system includes a processor. The processor is configured to acquire first communication status data between a first wireless device and each of multiple second wireless devices, perform a first estimation process to estimate a position of the first wireless device using the first communication status data, and perform a second estimation process to estimate the position of the first wireless device using an output of a trained model. The first communication status data is acquired at different intervals depending on a channel. The first or second estimation process is selected based on the first communication status data. The trained model is built by using the training data including second communication status data.

### CROSS-REFERENCE TO RELATED APPLICATIONS

This application is based upon and claims the benefit of priority from Japanese Patent Application No. 2024-034972, filed Mar. 7, 2024, the entire contents of which are incorporated herein by reference.

### FIELD

Embodiments described herein relate generally to a position estimation system.

### BACKGROUND

In recent years, for example, it has become common to estimate the position of a wireless device based on the strength of the signal (radio waves) observed between the device and another wireless device that has the function to perform wireless communication.

More specifically, the wireless device is a personal computer (hereafter referred to as PC) and, for example, estimating the position of the PC (employee) is considered to be useful in a case such as recognizing the position of people in an office building and efficiently controlling air conditioning.

However, the position of the above-described wireless device needs to be estimated at a high speed and with high accuracy.

### BRIEF DESCRIPTION OF THE DRAWINGS

FIG. 1 is a view showing an example of a configuration of a position estimation system according to an embodiment.

FIG. 2 is a block diagram showing an example of a functional configuration of a terminal device.

FIG. 3 is a block diagram showing an example of a functional configuration of a base station.

FIG. 4 is a block diagram showing an example of a functional configuration of a position estimation device.

FIG. 5 is a view showing an example of the system configuration of the position estimation device.

FIG. 6 is a flowchart showing an example of a procedure of the position estimation device.

FIG. 7 is a view illustrating an example of a method of obtaining a received signal strength.

FIG. 8 is a view illustrating another example of the method of obtaining the received signal strength.

FIG. 9 is a view illustrating yet another example of the method of obtaining the received signal strength.

FIG. 10 is a view illustrating yet another example of the method of obtaining the received signal strength.

FIG. 11 is a graph illustrating the accuracy of the position of the terminal device estimated by executing a first estimation process.

FIG. 12 is a view illustrating an overview of a trained model used in a second estimation process.

FIG. 13 is a view illustrating an overview of a trained model used in the second estimation process.

### DETAILED DESCRIPTION

In general, according to one embodiment, a position estimation system includes a processor. The processor is configured to acquire first communication status data related to a communication status between a first wireless device and each of multiple second wireless devices, perform a first estimation process to estimate a position of the first wireless device using the acquired first communication status data, perform a second estimation process to estimate the position of the first wireless device using an output of the trained model when the acquired first communication status data is input to the trained model. The first communication status data is acquired at different intervals depending on a channel connecting the first wireless device with each of the multiple second wireless devices. The first estimation process or the second estimation process is selected based on the first communication status data. The trained model is built by using the training data that includes second communication status data related to the communication status between the first wireless device and each of the multiple second wireless devices in a state in which the first wireless device is at a predetermined position.

Various embodiments will be described with reference to the accompanying drawings.

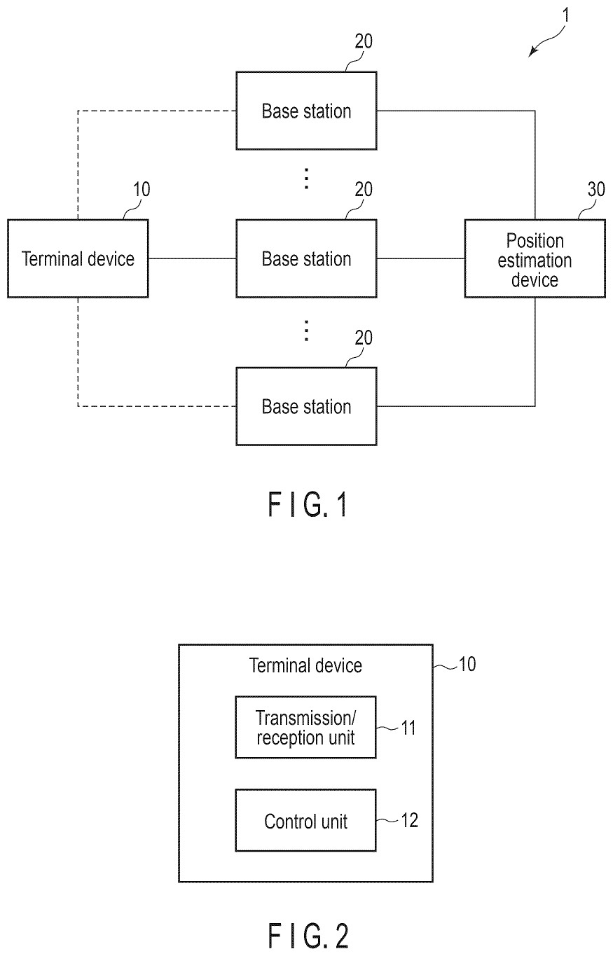

FIG. 1 shows an example of a configuration of a position estimation system according to an embodiment. The position estimation system 1 shown in FIG. 1 includes a terminal device 10, multiple base stations 20, and a position estimation device 30.

The terminal device 10 is an example of a wireless device including a function of executing wireless communication, and includes a notebook-type personal computer (notebook PC) used by, for example, a user (such as a company employee) who can move within a predetermined space such as an office building, but may also be the other electronic device such as a smartphone or may be a stationary device such as a desktop-type personal computer. In the embodiment, it is assumed that the terminal device 10 moves within a predetermined space together with the user.

The multiple base stations 20 are examples of wireless devices that include a function of executing wireless communication, and are arranged within the above-described predetermined space such as an office building. The terminal device 10 executes wireless communication with each of the multiple base stations 20 over a communication channel.

In this example, recognizing the position of the terminal device 10 used by a user moving in a predetermined space as described above (for example, a company employee moving inside an office building) corresponds to recognizing the position of the person (flow of person) in the space, and efficient air conditioning control, and the like in the space can be achieved by using data related to the position of the person (flow of person).

In this case, when it is considered that the communication status between the terminal device 10 and each of the multiple base stations 20 (hereinafter referred to as the communication status at the base station 20) depends on the distance between the terminal device 10 and the base station 20, it is thought that the position of the terminal device 10 can be estimated based on the communication status at each of the multiple base stations 20. Incidentally, in order to estimate the position of the terminal device 10 with high accuracy, it is desirable to use the communication status at a greater number of base stations 20.

However, the base stations 20 connected to the terminal device 10 over the communication channel are switched in accordance with the movement of the terminal device 10, and the terminal device 10 basically executes wireless communication with only one base station 20. For this reason, in order to recognize the communication status of the base stations 20 other than the base station 20 which executes wireless communication with the terminal device 10 over the communication channel, it is necessary to execute scanning (off-channel scanning) using an observation channel which is different from the communication channel.

In contrast, since actually necessary communication cannot be executed while scanning on the observation channel, executing scanning on the observation channel at a short interval (high frequency) may be a factor which causes degradation in network performance. It is therefore necessary to execute scanning on the observation channel at a long interval (low frequency) (in other words, to reduce the time ratio of scanning on the observation channel).

However, if scanning on the observation channel is executed at a long interval (low frequency) as described above, it may take time to recognize the communication status at a certain number of base stations 20, which is sufficient to estimate the position of the terminal device 10 with high accuracy, and it may not be possible to speed up the estimation of position of the terminal device 10. In addition, if the position of the terminal device 10 is estimated without recognizing the communication status at a certain number of base stations 20, which is sufficient to estimate the position of the terminal device 10 with high accuracy, the accuracy in estimation of the position may be degraded.

Therefore, the position estimation device 30 of the embodiment provides a mechanism for estimating the position of the terminal device 10 at high speed and with high accuracy, based on communication status information indicating the communication status between the terminal device 10 and each of the multiple base stations 20.

Incidentally, in the embodiment, the communication status information will be described as, for example, received signal strength of packets (signals) observed between the terminal device 10 and each of the multiple base stations 20, such as Received Signal Strength Indicator (RSSI).

In addition, in the embodiment, it is assumed that the terminal device 10 and each of the multiple base stations 20 execute wireless communication based on wireless LAN as specified in IEEE 802.11. In this case, the terminal device 10 corresponds to a station (STA), and each of the multiple base stations 20 corresponds to an access point (AP).

In IEEE 802.11k, a standard for the base stations 20 to scan observation channels other than the communication channels used for wireless communication in order to determine the status of use of radio waves is defined. Accordingly, for example, the communication between the terminal device 10 and a predetermined base station 20 can be observed by the other base stations 20 (i.e., the received signal strength at the other base stations 20 can be recognized).

Incidentally, in the embodiment, the status in which multiple base stations 20 are arranged (installed) at a relatively high density, in a predetermined space such as an office building is assumed, and it is assumed that even if (the user using) the terminal device 10 moves in the predetermined space, the received signal strength at each of the multiple base stations 20 can be measured using the communication channel and observation channel. Furthermore, as described above, the received signal strength at the base station 20 that executes wireless communication with the terminal device 10 over the communication channel (i.e., one of the multiple base stations 20) can be measured (obtained) at a relatively short interval (high frequency) using the communication channel. In contrast, it is assumed that the received signal strength at the base station 20 other than the base station 20 that executes wireless communication with the terminal device 10 over the communication channel (i.e., the other of the multiple base stations 20) is measured (acquired) at a relatively long interval (low frequency) using the observation channel as compared to the communication channel.

FIG. 2 is a block diagram showing an example of a functional configuration of the terminal device 10 shown in FIG. 1. As shown in FIG. 2, the terminal device 10 includes a transmission/reception unit 11 and a control unit 12.

The transmission/reception unit 11 is a functional unit for transmitting and receiving various packets to and from each of the multiple base stations 20. The control unit 12 is a functional unit for controlling the operation of the terminal device 10.

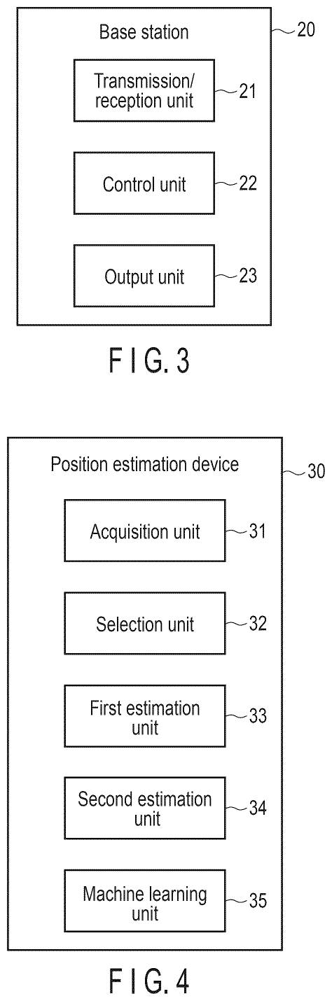

FIG. 3 is a block diagram showing an example of a functional configuration of the base station 20 shown in FIG. 1. As shown in FIG. 3, the base station 20 includes a transmission/reception unit 21, a control unit 22, and an output unit 23.

The transmission/reception unit 21 is a functional unit for transmitting and receiving various packets to and from the terminal device 10. The control unit 22 is a functional unit for controlling the operation of the base unit 20. The output unit 23 is a functional unit for outputting the received signal strength (received signal strength at the base station 20) of the packets observed using the communication channel or observation channel described above.

FIG. 4 is a block diagram showing an example of a functional configuration of the position estimation device 30 shown in FIG. 1. As shown in FIG. 4, the position estimation device 30 includes an acquisition unit 31, a selection unit 32, a first estimation unit 33, a second estimation unit 34, and a machine learning unit 35.

The position estimation device 30 is connected to each of the multiple base stations 20 to execute wired or wireless communication. For example, the acquisition unit 31 acquires the received signal strength at the base station 20, which is output from (the output unit 23 included in) each of the multiple base stations 20. Incidentally, the interval (frequency) at which the received signal strength is output from each of the multiple base stations 20 (i.e., the interval at which the received signal strength is acquired by the acquisition unit 31) differs depending on whether the received signal strength is the received signal strength of a packet observed using the communication channel or the received signal strength of a packet observed using the observation channel.

The selection unit 32 selects a first or second estimation process, based on the received signal strength acquired by the acquisition unit 31.

When the first estimation process is selected by the selection unit 32, the first estimation unit 33 executes the first estimation process. Incidentally, the first estimation process corresponds to the process of estimating the position of the terminal device 10 using the received signal strength acquired by the acquisition unit 31.

When the second estimation process is selected by the selection unit 32, the second estimation unit 34 executes the second estimation process. The second estimation unit 34 maintains a trained model to be described below. The second estimation process corresponds to a process of estimating the position of the terminal device 10 using the output of the trained model when the received signal strength acquired by the acquisition unit 31 is input to the trained model.

For example, the machine learning unit 35 learns the above-described trained model (i.e., builds the trained model) using the training data including the received signal strength at each of the multiple base stations 20 measured when the terminal device 10 is at the same position.

FIG. 5 is a view showing an example of a system configuration of the position estimation device 30 shown in FIG. 4. The position estimation device 30 includes a CPU 301, a nonvolatile memory 302, a RAM 303, a communication device 304, and the like.

The CPU 301 is a processor to control the operation of various components in the position estimation device 30. The CPU 301 may be a single processor or may be composed of multiple processors. The CPU 301 runs various programs loaded from the nonvolatile memory 302 into the RAM 303. The programs which are run by the CPU 301 include an operating system (OS) and various application programs.

The nonvolatile memory 302 is a storage medium used as an auxiliary storage device. The RAM 303 is a storage medium used as a main storage device. FIG. 5 shows only the nonvolatile memory 302 and the RAM 303. However, the position estimation device 30 may include, for example, the other storage devices such as a hard disk drive (HDD) and a solid state drive (SDD).

The communication device 304 is a device configured to execute wired communication or wireless communication.

Incidentally, in the embodiment, some or all of the units 31 to 35 shown in FIG. 4 can be realized by causing the CPU 301 (i.e., the computer of the position estimation device 30) to run a predetermined program, i.e., by software. This program may be stored in a computer-readable storage medium and distributed or may be downloaded to the position estimation device 30 through a network. Incidentally, some or all of the units 31 to 35 may be realized by dedicated hardware, or the like, or may be realized by combination of software and hardware.

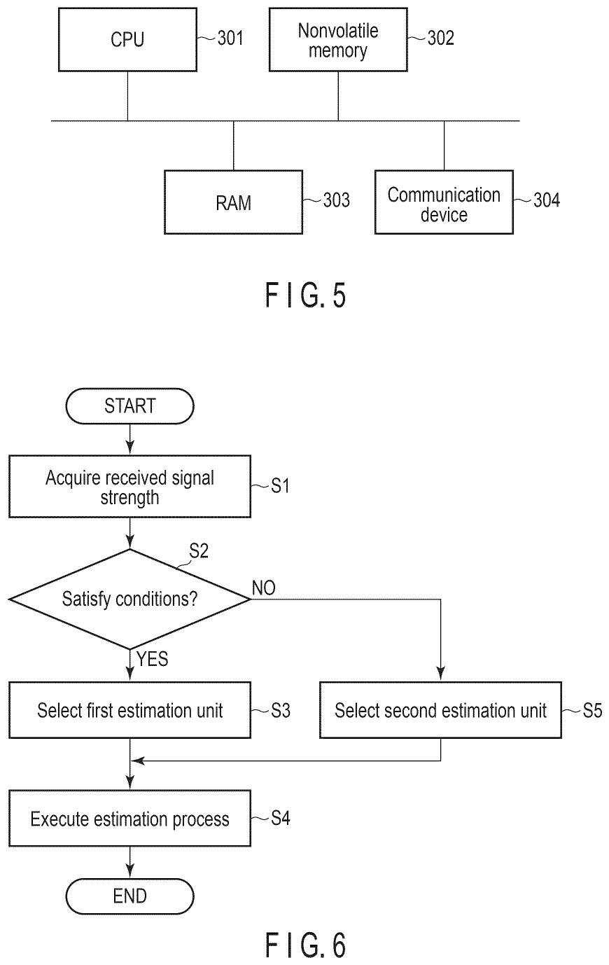

An example of a procedure of the position estimation device 30 according to the embodiment will be described below with reference to a flowchart of FIG. 6.

First, the acquisition unit 31 acquires the receiving signal strength at each of the multiple base stations 20 (step S1).

In the embodiment, the terminal device 10 can move in a predetermined space, and the terminal device 10 executes wireless communication over the communication channel with a base station 20 (hereinafter referred to as “first base station 20”) among the multiple base stations 20, depending on the position of the terminal device 10. In this case, the received signal strength at the first base station 20 is measured at a short interval (high frequency) using the communication channel.

In addition, the received signal strength at each of the multiple base stations 20 (hereinafter referred to as “second base stations 20”) other than the first base station 20 is measured at a long interval (low frequency) using the observation channel that is different from the communication channel.

In other words, in step S1, the received signal strength at the first base station 20 and the received signal strength at each of the multiple second base stations 20 are acquired at different intervals (timing). The received signal strength at each of the multiple base stations 20 (i.e., the first base station 20 and the multiple second base stations 20), which is thus acquired in step S1, is stored (accumulated) in the position estimation device 30 in association with the time at which the received signal strength is acquired and an identifier for identifying the base station 20 each time the received signal strength is acquired.

Incidentally, in the embodiment, the multiple base stations 20 (first and second base stations 20) are arranged (installed) at a relatively high density in the environment of an office building or the like, which is assumed to be a predetermined space. Therefore, even if the interval (frequency) of acquiring the received signal strength at each second base station 20 is low in such an environment, it can be expected that the interval between the acquisition of the received signal strength at any second base station 20 (packets are observed in any observation channel) is short.

In addition, the above-described received signal strength is acquired by unique methods provided by the manufacturers of the multiple base stations 20 (AP), methods based on the Simple Network Management Protocol (SNMP), or the like.

The method of acquiring the received signal strength of packets observed on the above-described observation channel will be described below. An example of wireless LAN under IEEE 802.11 will be described, and the standard for scanning the observation channel is assumed to be defined in IEEE 802.11k.

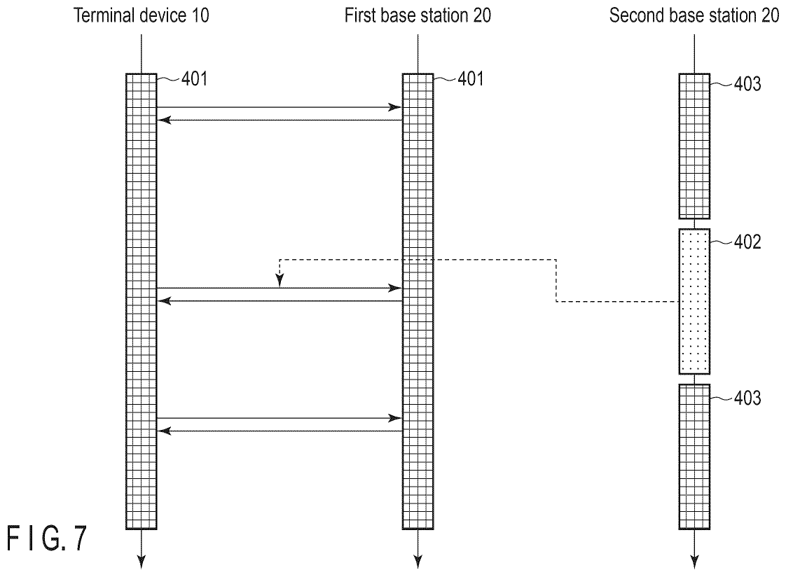

FIG. 7 is a view illustrating an example of a method of acquiring the received signal strength using the above-described observation channel.

In FIG. 7, the second base station 20 observes packets between the terminal device 10 and the first base station 20 by scanning at a short time ratio over the observation channel (off-channel) 402 which is different from the communication channel (on-channel) 401 over which the first base station 20 executes wireless communication with the terminal device 10, and measures the received signal strength of the packets (i.e., received signal strength at the second base station 20).

The received signal strength at the second base station 20, which is measured in this manner, is output from the second base station 20 to the position estimation device 30, and is acquired by the position estimation device 30 (acquisition unit 31).

Incidentally, for example, the second base station 20 can execute wireless communication with terminal devices other than the terminal device 10 over the communication channel 403, during the time other than scanning on the observation channel 402.

The method of acquiring the received signal strength using the observation channel has been described with reference to FIG. 7. For example, however, the received signal strength may also be acquired based on instructions from the first base station 20 (AP) to the terminal device 10 (STA). In this case, the terminal device 10 measures the received signal strength in response to the Beacon Measurement Request transmitted from the first base station 20, and operates to reply with the measured received signal strength as a Beacon Measurement Report.

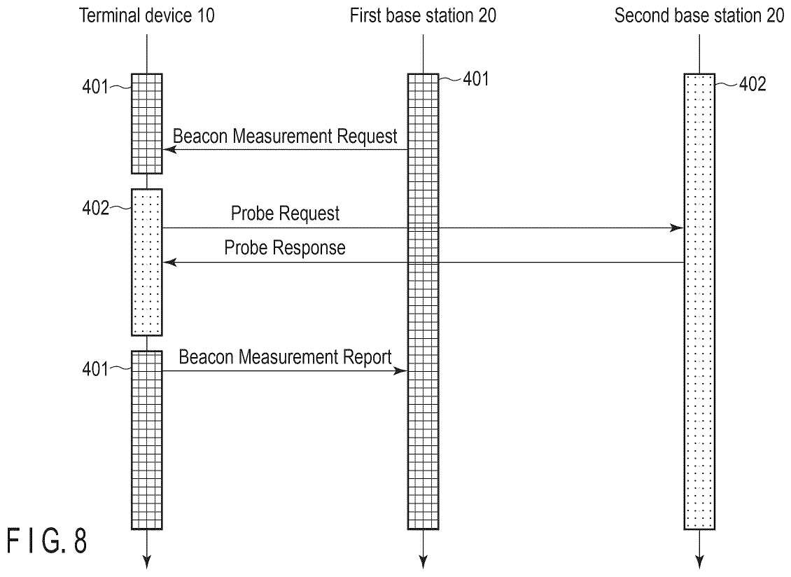

FIG. 8 shows another example of the method of acquiring the received signal strength using the observation channel. In this example, it is assumed that a mode (Measurement Mode) for measuring the received signal strength, which is set in advance, is active-all-ch or active-ch-rpt.

In FIG. 8, first, the first base station 20 instructs (transmits) a Beacon Measurement Request to the terminal device 10 over the communication channel 401.

Next, the terminal device 10 transmits a Probe Request to the second base station 20 over the observation channel (all or a specified channel) 402, and thereby observes (receives) the Probe Response transmitted from the second base station 20.

The terminal device 10 measures the received signal strength of the Probe Response (packet) thus observed as the received signal strength at the second base station 20, and transmits the measured received signal strength to the first base station 20 as a Beacon Measurement Report.

The received signal strength thus transmitted from the terminal device 10 to the first base station 20 is output from the first base station 20 to the position estimation device 30 and is acquired by the position estimation device 30 (acquisition unit 31).

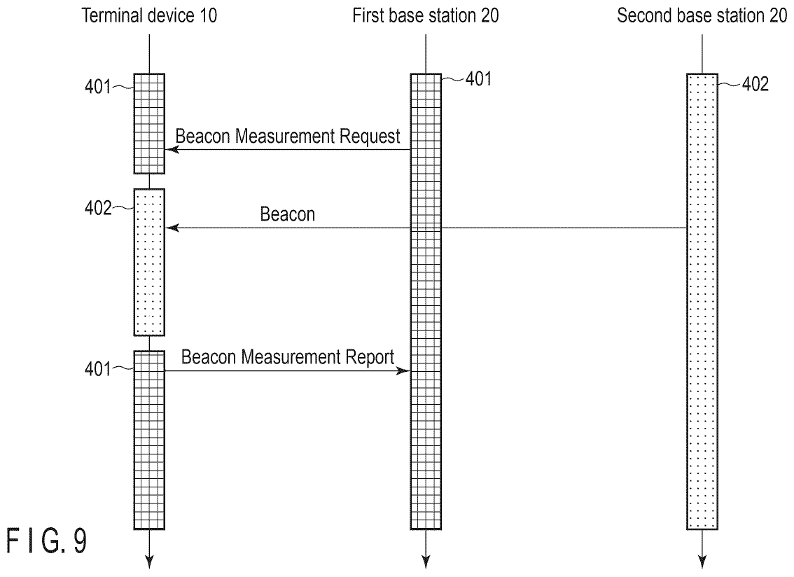

FIG. 9 shows yet another example of the method of acquiring the received signal strength using the observation channel. In this example, it is assumed that Measurement Mode is Passive.

In FIG. 9, first, the first base station 20 instructs (transmits) Beacon Measurement Request to the terminal device 10 over the communication channel 401.

Next, for example, the terminal device 10 observes (receives) the beacon, which is periodically transmitted from the second base station 20, by executing passive scanning over the observation channel (all or a specified channel) 402.

The terminal device 10 measures the received signal strength of Beacon (packet) thus observed as the received signal strength at the second base station 20, and transmits the observed received signal strength to the first base station 20 as Beacon Measurement Report.

The received signal strength thus transmitted from the terminal device 10 to the first base station 20 is output from the first base station 20 to the position estimation device 30 and is acquired by the position estimation device 30 (acquisition unit 31).

Incidentally, in the example shown in FIG. 9, unlike the above-described example shown in FIG. 8, the terminal device 10 can observe Beacon transmitted from the second base station 20 without transmitting Probe Request.

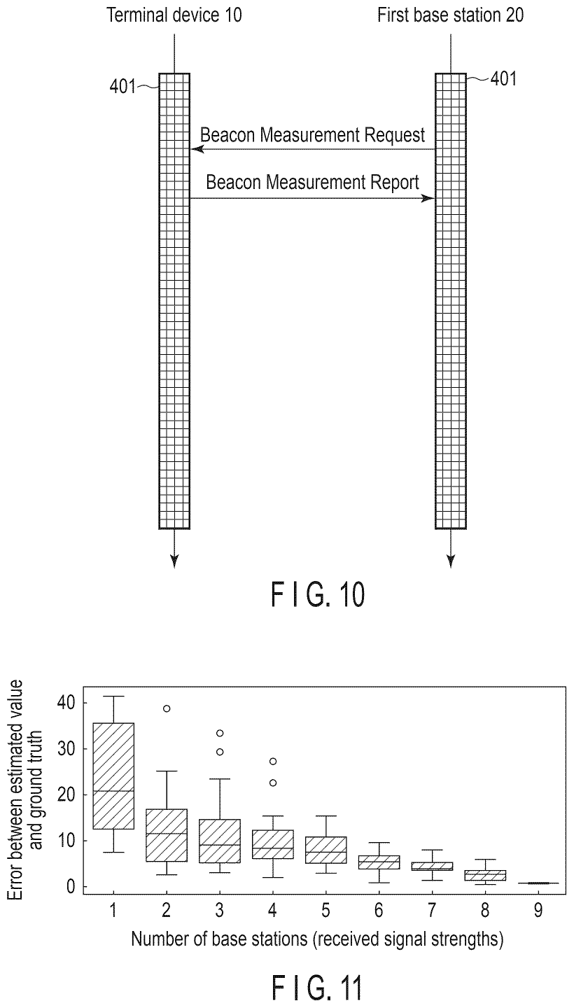

The embodiment has been described with reference to FIG. 8 and FIG. 9. For example, if the terminal device 10 manages a table holding (data of) the received signal strength of each of the multiple base stations 20 (first and second base stations 20) that have already been measured using the communication channel and the observation channel, the terminal device 10 may operate to transmit the received signal strength held in the table as Beacon Measurement Report, to the first base station 20 (i.e., to return results of the received signal strengths stored in the terminal device 10 as a whole to the second base station 20), in response to Beacon Measurement Request transmitted from the first base station 20, as shown in FIG. 10.

The received signal strength thus transmitted from the terminal device 10 to the first base station 20 is output from the first base station 20 to the position estimation device 30 and is acquired by the position estimation device 30 (acquisition unit 31).

Incidentally, the operation described with reference to FIG. 10 is assumed to be executed when Measurement Mode is beacon-table.

As described above, the position estimation device 30 (acquisition unit 31) of this embodiment can acquire the received strength at each of the multiple base stations 20, but the acquisition of said received strength may also be achieved by other methods.

Next, for example, the position estimation device 30 executes a process of estimating the position of the terminal device 10 using the received signal strength at each of the above-described multiple base stations 20 at predetermined timing.

As a position estimation method using the received signal strength, for example, applying trilateration using the received signal strengths measured (observed) at three points is considered. However, it is possible to improve the accuracy of position estimation (i.e., to reduce the error term) by increasing the points where the received signal strength is measured.

In this example, the received signal strength at each of the multiple second base stations 20 other than the first base station 20 that executes wireless communication with the terminal device 10 over the communication channel can be acquired by executing scanning over the observation channel (i.e., observing packets over the observation channel) as described above.

In the embodiment, however, one terminal device 10 is described for convenience. It is assumed that the terminal devices other than the terminal device 10 exist in the above-described predetermined space of the office building, or the like, and that each of the multiple second base stations 20 executes wireless communication with the other terminal devices over the communication channel.

In this case, the second base station 20 cannot execute scanning over the observation channel at the same time as executing wireless communication over the communication channel. Therefore, if the time taken for the scanning over the observation channel increases, the time taken for the second base station 20 to execute wireless communication over the communication channel decreases and the network performance may be degraded.

For this reason, for example, it is desirable to make the ratio of the time for scanning over the observation channel to the time for executing wireless communication over the communication channel as small as possible. In such a case, the interval (frequency) with which the received signal strength is acquired by scanning over the observation channel is lowed.

In other words, when estimating the position of the terminal device 10 using the received signal strength (i.e., received signal strength at multiple points) at each of the multiple base stations 20, it may take time to acquire the received signal strength at a sufficient number of base stations 20 (measurement points) in order to estimate the position of the terminal device 10 with high accuracy.

Therefore, in the embodiment, for example, the selection unit 32 maintains the conditions that is set in advance based on viewpoints such as whether the received signal strength is acquired to a degree to which the position of the terminal device 10 can be estimated with high accuracy. The estimation process selection conditions held in the selection unit 32 correspond to the conditions for selecting the first estimation process (first estimation unit 33) or the second estimation process (second estimation unit 34) (hereinafter referred to as “estimation process selection conditions”), and the selection unit 32 determines whether or not these estimation process selection conditions are met (step S2).

An example of the estimation process selection conditions used in step S2 will be described below.

First, it is considered that in order to estimate the position of the terminal device 10 with high accuracy as described above, the terminal device 10 needs to be located at a predetermined position during the period when the received signal strength at a sufficient number of base stations 20 is assumed to be measured (acquired).

For this reason, the above-described estimation process selection conditions include, for example, a condition that “the terminal device 10 is located at a predetermined position for a predetermined period (i.e., the time from the timing at which the terminal device 10 has moved to the present time is more than or equal to a certain time)” (hereinafter referred to as “first condition”). Incidentally, the situation that “the terminal device 10 is located at a predetermined position” is assumed to imply a case where the distance of movement is short enough to be considered that the terminal device 10 has not moved.

If the terminal device 10 moves in a predetermined space (for example, an office building), the received signal strength at the first base station 20 that executes wireless communication with the terminal device 10 over the communication channel (i.e., the received signal strength of the packets observed over the communication channel) changes depending on the movement of the terminal device 10 (i.e., the distance between the terminal device 10 and the first base station 20).

According to this, the timing at which the terminal device 10 has moved (i.e., whether or not the terminal device 10 has moved) can be determined based on the fact that the amount of change in the received signal strength of the packets observed over the communication channel among the received signal strengths stored in the position estimation device 30 is greater than or equal to a predetermined value (i.e., the received signal strength has increased or decreased by a certain amount or more).

Incidentally, the timing at which the terminal device 10 has moved may be determined based on the fact that the amount of change in the received signal strength observed over the predetermined observation channel is greater than or equal to a certain value.

In addition, if the terminal device 10 (for example, a notebook PC) is started up in a predetermined space, the acquisition of the received signal strength is executed immediately after the terminal device 10 is started up (i.e., the received signal strength at the position of the terminal device 10 is newly measured). Thus, the situation in which the received signal strength is newly measured can be considered to be the same as that when the terminal device 10 has moved.

For this reason, if the interval in the acquisition of the received signal strengths of the packets observed over the same channel (communication channel or observation channel) among the received signal strengths stored in the position estimation device 30 is a certain time or more, it may be determined as the timing when the terminal device 10 has moved (started up).

The case where the terminal device 10 is started up has been described. However, the conditions are the same as those in a case where the terminal device 10 that has already been started up enters a predetermined space, or the like.

Furthermore, when the terminal device 10 moves in a predetermined space, the base station 20 to which the terminal device 10 is connected over the communication channel (i.e., executes the wireless communication) may be changed (switched).

According to this, the timing at which the terminal device 10 has moved may be determined based on the fact that the base station 20 (AP) to which the terminal device 10 is connected over the communication channel has been changed.

Furthermore, in order to estimate the position of the terminal device 10 with high accuracy, it is desirable that the received signal strength at a sufficient number of base stations 20 is acquired.

For this reason, the above-described estimation process selection conditions may include a condition such as “the number of base stations 20 for which the received signal strength has been acquired is a certain number or more” (hereinafter referred to as “second condition”). Incidentally, the number of base stations 20 for which the received signal strength has been acquired can be acquired by counting the number of base stations 20 for which the received signal strength has been acquired from the timing at which the above-described terminal device 10 has moved to the present time with reference to the received signal strength stored in the position estimation device 30.

Incidentally, the estimation process selection conditions may be at least one of the first and second conditions, or may be conditions obtained by partially modifying some parts of the first or second conditions.

Furthermore, the estimation process selection conditions may be conditions prepared by combining the first and second conditions. More specifically, according to the estimation process selection conditions obtained by combining the above-described first and second conditions, whether or not the received signal strengths at a sufficient number of base stations 20 have been acquired when the terminal device 10 is located at a predetermined position can be determined.

Incidentally, the estimation process selection conditions in the embodiment may be any conditions set based on the viewpoint such as whether the received signal strength is acquired such that the position of the terminal device 10 can be estimated with high accuracy as described above, and are not limited to those described here.

If it is determined that the estimation process selection conditions are met (step S2: YES), the selection unit 32 selects the first estimation process (first estimation unit 33) (step S3).

When the process in step S3 is executed, the first estimation unit 33 executes the first estimation process (step S4).

In contrast, if it is determined that the estimation process selection conditions are not met (NO in Step S2), the selection unit 32 selects the second estimation process (second estimation unit 34) (step S5).

When the process in step S5 is executed, the second estimation unit 34 executes the second estimation process in step S4.

According to the above-described processes shown in FIG. 6, the first estimation process can be executed if, for example, the terminal device 10 remains at the same position for a certain period or longer and the received signal strengths at a sufficient number of base stations 20 are acquired (observed), and the second estimation process can be executed if, for example, the received signal strengths at a sufficient number of base stations 20 are not acquired (observed) immediately after the terminal device 10 moves (i.e., the first and second estimation processes can be switched based on the estimation process selection conditions).

Incidentally, in the embodiment, the first or second estimation process can be selected (i.e., the first and second estimation processes can be switched) based on the received signal strength at each of the multiple base stations 20 stored in the position estimation device 30. For example, however, if the received signal strength described with reference to FIG. 10 is acquired in step S1, the acquired received signal strength may include, for example, the received signal strength measured before the timing at which the terminal device 10 has moved previously. In this case, in the embodiment, when the terminal device 10 moves as described above, the second estimation process is selected (i.e., the first estimation process is switched to the second estimation process). Therefore, by retaining (the information indicating) the timing at which the estimation process is switched in the position estimation device 30, only the received signal strength acquired after that timing (i.e., the received signal strength acquired after the terminal device 10 has moved) may be used when the first or second estimation process is selected. The received signal strengths used when selecting the first or second estimation process have been described. However, the received signal strengths used in the first and second estimation processes to be described below are the same as those described above.

The first and second estimation processes in the embodiment will be described below. First, the first estimation process is executed when the terminal device 10 remains at the same position for a sufficiently long time, as described above, and the received signal strength at each of all base stations 20 located in the vicinity of the position (i.e., base stations 20 located near the terminal device 10) is acquired. In the first estimation process, the received signal strength acquired from the timing when the terminal device 10 has moved until the present time is used among the received signal strengths stored in the position estimation device 30 (i.e., the received signal strengths acquired by the acquisition unit 31).

In general, a relationship between the received signal strength (RSSI) and the distance is expressed by the following formula (1). Incidentally, to simplify the formula, the only received signal strength in the 2.4 GHz band is focused.

$${rssi}_{i} = A - 10 * {n}_{i} * {log}_{10} ( \sqrt{{( {x}_{i} - x )}^{2} + {( {y}_{i} - y )}^{2} + ( {z}_{i} - {z}^{2} )} ) \qquad Formula ( 1 )$$

In formula (1), i represents an index assigned to each base station 20 (AP), rssiᵢ represents the received signal strength of the base station 20 whose index is i (hereafter referred to as base station 20-i), and xᵢ, yᵢ, and zᵢ represent the position (x, y, and z coordinate values) of the base station 20-i. In addition, in formula (1), x, y, and z represent the position of the terminal device 10. Furthermore, in formula (1), A represents the received signal strength when the distance between the terminal device 10 and the base station 20-i is 1 m, which is different from for each terminal device 10. Incidentally, since A represents the received signal strength when the distance between the terminal device 10 and the base station 20-i is sufficiently short, it can be said that the received signal strength is equivalent to the transmitted signal strength of the terminal device 10. In addition, in formula (1), nᵢ represents an attenuation constant, and nᵢ=2 in an ideal free space. However, it is known that nᵢ fluctuates in a complex manner depending on the surrounding conditions in an indoor environment, the positions of the terminal device 10 and the base station 20-i, and the like, and nᵢ takes a value between 2 and 6 in many cases.

Incidentally, in the embodiment, the position of each of the multiple base stations 20 is assumed to be held (registered) in advance, and the values of xᵢ, yᵢ, and zᵢ, which indicate the position of the above-described base station 20-i are known. In addition, if the terminal device 10 is a notebook PC and is placed on a desk or the like for use, the position of the terminal device 10 in the height direction can be expected to be approximately 1 m, and z is also assumed to be known. Furthermore, if all nᵢ are assumed to take the same value n, unknown variables in formula (1) are four variables, i.e., A, n, x, and y.

In this case, the above-mentioned unknown variables A, n, x, and y can be obtained by solving the minimization problem expressed by the following formula (2).

$$minimize {\sum }_{i ∈ AP} {( {d}_{rssi , i} - \sqrt{{( {x}_{i} - x )}^{2} + {( {y}_{i} - y )}^{2} + ( {z}_{i} - {z}^{2} )} )}^{2} \qquad Formula ( 2 )$$

$$where {d}_{rssi , i} = {10}^{\frac{A - {rssi}_{i}}{10 n}}$$

In formula (2), d_{rssi, i} represents the distance between the terminal device 10 and the base station 20-i, which is calculated from rssiᵢ (i.e., the received signal strength at the base station 20-i) described above.

In the embodiment, the x, y and the above-mentioned known z (i.e., x, y, and z) obtained by solving such a minimization problem correspond to the position of the terminal device 10, which is the estimation result of the first estimation process.

Incidentally, when the minimization problem expressed by the above-mentioned formula (2) is solved, a constraint condition that the position of the terminal device 10 is in a predetermined space (i.e., an office building) may be added as needed. Furthermore, A may be used to represent a fixed value by using the knowledge that the transmission power of the terminal device 10 (for example, a notebook PC) is generally the same.

FIG. 11 is a box plot diagram with the vertical axis showing an error between the position (estimated value) of the terminal device 10 estimated by executing the first estimation process and an actual position (ground truth) of the terminal device 10, and a horizontal axis showing the number of (received signal strengths at) base stations 20 used in the first estimation process.

It is shown in FIG. 6 that the error between the estimated value and the ground truth becomes smaller as the number of base stations 20 increases, and it can be understood that the accuracy in estimation of the position of the terminal device 10 is improved.

As described above, in the first estimation process, it is considered that if the terminal device 10 is sufficiently stationary and the received signal strengths (RSSI) of a large number of base stations 20 are acquired, relatively high-accuracy position estimation can be executed.

Incidentally, the first estimation process described here is just one example, and the other processes may be executed as long as they estimate the position of the terminal device 10 using the received signal strengths at a sufficient number of base stations 20, which are acquired during the period when the terminal device 10 is located at a predetermined position.

Incidentally, as described above, A, which is used to estimate the position of the terminal device 10 in the first estimation process, is the received signal strength at a distance of 1 m between the terminal device 10 and the base station 20-i, and is equivalent to the transmitted signal strength of the signal transmitted from the terminal device 10. In the embodiment, A may be an unknown constant. However, since A is generally determined according to, for example, the type of the terminal device 10 such as a notebook PC or smartphone, A may be determined according to the type of terminal device 10 and applied to formula (2). According to this, A is set based on the type of terminal device 10, and the optimization problem can be solved with fewer unknowns (the solution space is reduced, which allows for higher accuracy in estimation).

Incidentally, the type of terminal device 10 can be estimated by, for example, using the vendor ID included in the MAC address used in wireless communication, or by using information on whether or not mobile communication can be executed, which is included in Probe Request from the terminal device 10 (i.e., information on the type of terminal device 10), and the like.

In addition, it has been described that the first estimation process is executed by targeting only the received signal strength in the 2.4 GHz band. However, the propagation characteristics differ depending on the frequency band of the radio waves used for wireless communication. In wireless LAN, two frequency band, 2.4 GHz band and 5 GHz band, are mainly used. In this case, the first estimation process may be executed by distinguishing between the 2.4 GHz band and the 5 GHz band. The first estimation process has been described here. However, the second estimation process may be executed in the same manner.

Furthermore, when each of the multiple base stations 20 includes multiple antennas, the multiple antennas arranged at the same base station 20 have different characteristics depending on the direction and position of the antennas. For this reason, for example, if one base station 20 includes first and second antennas and packets are observed using each of the first and second antennas, the received signal strength of the packets observed using the first antenna and the received signal strength of the packets observed using the second antenna may be distinguished (i.e., treated as separate received signal strengths) in the first estimation process. The first estimation process has been described here. However, the second estimation process may be executed in the same manner.

In addition, as described above, when using Beacon Measurement Report, the terminal device 10 measures the received signal strength. However, if the transmitted signal strength of each base station 20 (i.e., the transmitted signal strength of the signal transmitted from the base station 20) is known, a value obtained by subtracting the received signal strength from the transmitted signal strength (i.e., the difference between the transmitted signal strength and the received signal strength) becomes an attenuation term of the radio waves. In other words, when using the value obtained by subtracting the received signal strength from the transmitted signal strength, the first estimation process can be executed using a formula which does not require A.

Incidentally, in the above formula (2), it has been described that the position of (multiple base stations 20 including) the base station 20-i is known. However, (the information indicating) the position of each of the base stations 20 may be acquired from the base station 20 via a wireless LAN controller (wireless device), for example, based on SNMP or the like. In addition, if the base station 20 responds to Location Configuration Information (LCI) request (i.e., if a base station 20 that supports LCI is used), the position estimation device 30 may acquire the position of the base station 20 by means of the LCI request.

In addition, if the position of each of the multiple base stations 20 cannot be acquired as described above, for example, drawings for installation constructions of the base station 20 or the position input (indicated) by a user who has visually confirmed the position of the base station 20 arranged in a predetermined space may be used.

In some cases, however, the base station 20 cannot be arranged (installed) as indicated by the above-mentioned drawings for installation construction or even if the position based on the drawings or the like is input, the position may be different from the actual position of the base station 20. In this case, for example, the received signal strength at each of the multiple base stations 20 may be measured by transmitting and receiving the packets between the multiple base stations 20, the position of the predetermined base station 20 may be estimated using the received signal strength, and the position input as described above may be corrected based on the estimated position (i.e., the input position may be corrected to the estimated position). Incidentally, when estimating the position of the base station 20 using the received signal strength, for example, the same process as the above-described first estimation process may be executed.

Next, the second estimation process will be described. As described above, the first estimation process is executed when the received signal strengths at a sufficient number of base stations 20 are acquired in the state in which the terminal device 10 is located in a predetermined position (i.e., stays at the same position) while the second estimation process is executed when the received signal strengths at a sufficient number of base stations 20 are not acquired. Incidentally, in the second estimation process, similarly to the first estimation process, the received signal strength acquired from the timing when the terminal device 10 has moved until the present time is used among the received signal strengths stored in the position estimation device 30 (i.e., the received signal strengths acquired by the acquisition unit 31).

The number of received signal strengths used in the second estimation process is not sufficient to estimate the position of the terminal device 10 with high accuracy. However, if the same process as the first estimation process is executed using only these received signal strengths, the accuracy in results of the estimation of the position of the terminal device 10 is considered to be low.

Therefore, in the second estimation process, for example, the position of the terminal device 10 is estimated using a trained model built by applying a known machine learning algorithm such as a neural network.

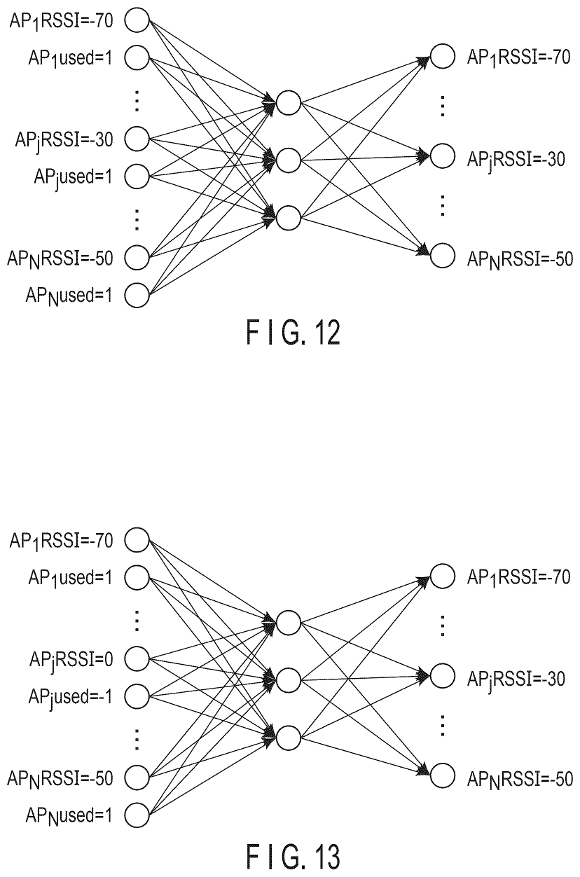

An outline of the trained model used in the second estimation process will be described below with reference to FIG. 12 and FIG. 13.

First, it is assumed that, for example, the received signal strengths at all base stations 20 in the vicinity of the terminal device 10 are acquired and accumulated by keeping the terminal device 10 stationary (i.e., at a predetermined position) for a sufficient period of time at the same position in a predetermined space, before the operation of the position estimation system 1.

In this case, in the embodiment, by using the training data that includes the received signal strengths and the ground truth at all base stations 20, which have been accumulated as described above (i.e., by learning from the training data), a trained model that outputs the ground truths when the received signal strengths are input is built (constructed).

Incidentally, in the embodiment, the ground truths are assumed to be the received signal strengths at all base stations 20 in the vicinity of the terminal device 10, which have been accumulated as described above.

FIG. 12 shows a concept of the trained model which is trained using the received signal strengths at all base stations 20 as described above.

In FIG. 12, it is assumed that N base stations 20 are arranged in a predetermined space, and the received signal strength at base station 20-i (i=1, 2, . . . , j, . . . , N) among N base stations 20 is represented by APᵢRSSI, and whether or not the received signal strength has been acquired is represented by APᵢused. Incidentally, when APᵢused=1, it is indicated that the received signal strength at base station 20-i is acquired, and when APᵢused=0, it is indicated that the received signal strength at base station 20-i is not acquired.

Incidentally, for example, if the received signal strength at base station 20-i is acquired multiple times while the terminal device 10 is moved from the predetermined position to the same position, the received signal strength at base station 20-i included in the training data may be the received signal strength which is subjected to preprocessing such as calculating the average of the received signal strengths acquired multiple times.

In other words, FIG. 12 shows the learning phase of constructing a trained model (neural network) capable of outputting the received signal strengths (estimated values) at all base stations 20-1 to 20-N when the received signal strengths at all base stations 20-1 to 20-N are input.

Furthermore, if it is assumed that the received signal strengths at all base stations 20 are accumulated as described above, in the embodiment, a trained model of outputting the received signal strengths (i.e., ground truths) at all base stations 20 when the received signal strengths are input is built by using the training data including the received signal strengths at some base stations 20 among all the base stations 20 (i.e., by learning from the received signal strengths at some base stations 20).

Incidentally, the received signal strengths at some base stations 20, which are used as the training data, may be extracted intentionally or randomly from the received signal strengths at all the base stations 20.

FIG. 13 shows a concept of the trained model which is trained using the received signal strengths at some base stations 20 as described above.

In FIG. 13, it is shown that APⱼused=−1 and that the received signal strength at base station 20-j is not used as the training data.

In other words, FIG. 13 shows the learning phase of constructing a trained model (neural network) capable of outputting the received signal strengths (estimated values) at all base stations 20-1 to 20-N when the received signal strengths at some base stations 20 except, for example, at least the base station 20-j among all the base stations 20-1 to 20-N are input.

By performing the learning described above with reference to FIG. 12 and FIG. 13, the trained model capable of outputting the received signal strengths at all base stations 20 is built even when only the received signal strengths at a limited number of base stations 20 are input.

In this case, it has been described that the learning is executed using the received signal strength acquired when the terminal device 10 is located at a predetermined position (stationary at the same position). However, a high-accuracy trained model can be generated by repeating the learning for each position of the terminal device 10.

In addition, the processing of generating the trained model in the embodiment (i.e., the processing related to training of the trained model) is assumed to be executed by the machine learning unit 35 included in the position estimation device 30. However, it may also be executed outside the position estimation device 30.

As described above, when the second estimation process is executed in the embodiment, the received signal strengths at a sufficient number of base stations 20 are not obtained (i.e., only the received signal strengths at some of the base stations 20 are obtained). However, the second estimation unit 34 can acquire the received signal strengths at all of the base stations 20, which are output from the trained model, by inputting the received signal strengths at some of the base stations 20 to the above-described trained model.

Since the received signal strengths at all the base stations 20 acquired in this manner correspond to the received signal strengths at a sufficient number of base stations 20, which are acquired when the above-described terminal device 10 is located at a predetermined position, the second estimation unit 34 can estimate the position of the terminal device 10 with high accuracy by executing the same process as the above-described first estimation process using the acquired received signal strengths (i.e., the output of the trained model).

In the embodiment, the trained model that is generated to output the received power at all the base stations 20 by inputting the received power at some base stations 20 has been described. For example, however, the trained model may also be generated to output the position (estimated value) of the terminal device 10 by inputting the received power at some base stations 20.

Such a trained model is built by learning from the training data which includes the received signal strengths at all the base stations 20, which are acquired and accumulated as described above, the received signal strengths at some of the base stations 20 among all the base stations 20, and the position (ground truth) of the terminal device 10 when the received signal strengths are measured.

Incidentally, the position of the terminal device 10 used as the ground truth in the training of the trained model that outputs the position of the terminal device 10 may be, for example, the position of the terminal device 10 estimated by executing the first estimation process using the received signal strengths at all the base stations 20 (i.e., the estimation result of the first estimation process), or may be the actual measured value measured using various sensors, the position input by the user, or the like.

As described above, the position estimation system 1 (position estimation device 30) according to the embodiment includes the first estimation unit 33 which estimates the position of the terminal device 10 using the received signal strength at each of the multiple base stations 20 arranged in the predetermined space in which the terminal device 10 moves (i.e., the first communication status data concerning the communication status between the first wireless device moving in the space and each of the multiple second wireless devices arranged in the space), and the second estimation unit 34 which estimates the position of the terminal device 10 using the output of the trained model when the received signal strength is input to the trained model.

In this case, the received signal strength at each of the multiple base stations 20 is acquired at different intervals depending on the channel connecting the terminal device 10 with each of the multiple base stations 20. In addition, the process executed by the first estimation unit 33 (first estimation process) or the process executed by the second estimation unit 34 (second estimation process) is selected based on the received signal strength at each of the multiple base stations 20.

Furthermore, the trained model is built by using the training data including the received signal strength at each of the multiple base stations 20, which is acquired (measured) when the terminal device 10 is located at a predetermined position (located at the same position) (i.e., the second communication status data related to the communication status between the terminal device 10 and each of the multiple base stations 20). By learning from such training data, the trained model may be built to output the received signal strength at each of the multiple base stations 20 (for example, all the base stations 20) by inputting the received signal strengths at at least some of the multiple base stations 20. In addition, by learning from the training data including the received signal strength at each of the multiple base stations 20 and the estimation result of the first estimation process using the received signal strength, the trained model may be built to output the position (estimated value) of the terminal device 10 by inputting the received signal strengths at at least some of the multiple base stations 20.

Incidentally, in the embodiment, the received signal strength at the first base station 20 (i.e., the first communication status data relating to the communication status between the terminal device 10 and some of the multiple base stations 20) is measured (acquired) at a short interval (high frequency) using the communication channel. In addition, in the embodiment, the received signal strength at the second base station 20 (i.e., the first communication status data relating to the communication status between the terminal device 10 and the others of the multiple base stations 20) is measured (acquired) at a long interval (low frequency) using the observation channel.

In the embodiment, the position of the terminal device 10 can be estimated at high speed with high accuracy by the above-described configuration.

More specifically, in the embodiment, for example, if the received signal strength is acquired such that the position of the terminal device 10 can be estimated with high accuracy, the first estimation process is selected and the position of the terminal device 10 can be estimated with high accuracy by executing the first estimation process.

More specifically, in the embodiment, for example, if the received signal strengths (i.e., the received signal strengths at a sufficient number of base stations 20) are not acquired such that the position of the terminal device 10 can be estimated with high accuracy, the second estimation process is selected.

Since this second estimation process is executed without waiting until the received signals strength at a sufficient number of base stations 20 are acquired, faster process of estimating the position of the terminal device 10 can be achieved.

Furthermore, in the second estimation process, by using the trained model built by using the above-described training data (for example, the trained model that can output the received signal strength at each of all the base stations 20 by inputting the received signal strengths at some base stations 20), it is possible to achieve the accuracy in estimation of the position of the terminal device 10 at the same level as the first estimation process using the received signal strengths at a sufficient number of base stations 20.

Incidentally, in the embodiment, it has been described that one terminal device 10 is provided for convenience. However, in an environment where multiple terminal devices 10 move in a predetermined space, the received signal strength at the base station 20 and the identifier for identifying the terminal device 10 may be acquired for each of the terminal devices 10, and the position of each of the multiple terminal devices 10 may be estimated based on the received signal strength acquired for each of the terminal devices 10.

In addition, the received signal strength acquired as described above is stored in the position estimation system 1 (for example, inside the position estimation device 30) in association with the time at which the received signal strength is acquired. With this type of configuration, the first or second estimation process can be selected using the time at which the received signal strength is acquired.

More specifically, if the amount of change in the received signal strength at at least one base station 20 (for example, the first base station 20) among the multiple base stations 20 is greater than or equal to a predetermined value, the second estimation process may be selected. In addition, if the interval of acquisition in the received signal strength at at least one base station 20 (for example, the first base station 20) among the multiple base stations 20 is greater than or equal to a predetermined value, the second estimation process may be selected. Furthermore, if the base station 20 connected to the terminal device 10 over the communication channel is changed, the second estimation process may be selected. With such a configuration, it is possible to determine that the terminal device 10 has moved and to switch the first estimation process to the second estimation process.

In addition, if the number of base stations 20 from which the received signal strengths are acquired when the terminal device 10 is located at a predetermined position is less than a predetermined value, the second estimation process may be selected. With such a configuration, if the received signal strength at the required number of base stations 20 for the first estimation process is not acquired, the position of the terminal device 10 can be estimated with high accuracy using the second estimation process.

It has been described that the first or second estimation process is selected using the time at which the received signal strength is acquired. However, the time at which the received signal strength is acquired is also used when the first or second estimation process is executed. More specifically, the first or second estimation process is assumed to be executed using the received signal strength acquired during the period when the terminal device 10 is located at a predetermined position (i.e., a period from the time at which the terminal device 10 moves to the present time).

Furthermore, in the first estimation process, the position of the terminal device 10 may be estimated using the transmitted signal strength of the packets (signals) transmitted from the terminal device 10. Incidentally, this transmitted signal strength may be acquired based on the type of terminal device 10 (for example, notebook PC, smartphone, or the like). With such a configuration, improvement in the accuracy of estimation of the position of the terminal device 10 can be expected.

In addition, in the first estimation process, the position of the terminal device 10 may be estimated based on the frequency band of the channel. With such a configuration, estimation of the position of the terminal device 10 in consideration of the fact that the propagation characteristics differ depending on the frequency of the channel can be achieved.

Furthermore, in the first estimation process, if multiple antennas are built in each of the multiple base stations 20, the received signal strength acquired for each of these antennas may be used. With such a configuration, when multiple base stations 20 (AP) including multiple antennas are arranged, the accuracy of the estimation of position of the terminal device 10 may be improved by using the information on the antenna used to observe the packet for measuring the received signal strength (in other words, by distinguishing the received signal strengths of the packets observed using different antennas).

In addition, in the first estimation process, the position of the terminal device 10 may be estimated using the transmitted signal strengths of the packets (signals) transmitted from the multiple base stations 20. With such a configuration, the number of unknowns in the optimization problem expressed by the above-mentioned formula (2) can be reduced.

Furthermore, in the first estimation process, the position of the terminal device 10 is estimated using the position of each of the multiple base stations 20. The position of each of the multiple base stations 20 may be acquired from the base stations 20 or, for example, may be held in advance in the position estimation device 30. Furthermore, the position of each of the multiple base stations 20 may be estimated based on, for example, the received signal strength measured between the base stations 20.

Incidentally, in the embodiment, the first estimation process estimates the position of the terminal device 10 by, for example, applying the received signal strength at each of the multiple base stations 20 to the minimization problem (a formula for radio wave propagation) expressed by formula (2). However, the process may use a formula other than that described in this embodiment.

Incidentally, the first estimation process has been described. However, the description of the first estimation process can also be applied to the same process as the first estimation process that is executed using the output of the trained model in the second estimation process.

In the embodiment, it has been described that the communication status data is the received power (data). However, the communication status data may be any data related to the communication status between the terminal device 10 and each of the multiple base stations 20 and, for example, a bit error rate or the like may be used as the communication status data.

In addition, in the embodiment, it has been described that the position estimation device 30 includes the units 31 to 35 shown in FIG. 4. However, at least some of these units 31 to 35 may be located outside the position estimation device 30. Furthermore, the position estimation device 30 may be implemented by multiple devices, and the unit 31 to 35 may be arranged in different devices.

In the embodiment, estimating the position of the terminal device 10 such as a notebook PC used by a user moving in a predetermined space has been described. However, the embodiment can also be applied to a case of estimating the position of a wireless device arranged within the space, and can also be applied to a case where the terminal device 10 is an installation type device. For example, if the terminal device 10 is a desktop-type personal computer, it may be difficult to obtain a sufficient radio wave strength for position estimation over the communication channel immediately after startup. In such a situation, position estimation may be executed by scanning the observation channel, and then the position estimation may be executed by scanning the communication channel when a sufficient radio wave strength is obtained over the communication channel. In addition, for example, a configuration of estimating the position of a predetermined base station 20 or the like may be applied.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

As regards the above-described embodiment, the following motes are further disclosed.

(1)

A position estimation system including a processor configured to:
acquire first communication status data related to a communication status between a first wireless device and each of multiple second wireless devices;
perform a first estimation process to estimate a position of the first wireless device using the acquired first communication status data; and
perform a second estimation process to estimate the position of the first wireless device using an output of a trained model when the acquired first communication status data is input to the trained model, wherein
the first communication status data is acquired at different intervals depending on a channel connecting the first wireless device with each of the multiple second wireless devices,
the first estimation process or the second estimation process is selected based on the first communication status data, and
the trained model is built by using the training data that includes second communication status data related to the communication status between the first wireless device and each of the multiple second wireless devices in a state in which the first wireless device is at a predetermined position.

(2)

The position estimation system of (1), wherein
the first communication status data related to the communication status between the first wireless device and one of the multiple second wireless devices is measured at a short interval using a communication channel for executing wireless communication with the first wireless device, and
the first communication status data related to the communication status between the first wireless device and the other of the multiple second wireless devices is measured at a long interval using an observation channel different from the communication channel.

(3)

The position estimation system of (1) or (2), wherein
the first and second communication status data includes a received signal strength of the signal observed between the first wireless device and each of the multiple base stations.

(4)

The position estimation system of one of (1) to (3), wherein
the first wireless device includes a terminal device used by a user, and the second wireless device includes a base station.

(5)

The position estimation system of one of (1) to (4), wherein the processor is configured to:
when multiple first wireless devices move, acquire, in the first and second estimation processes, the first communication status data for each of the first wireless devices, and
estimate a position of each of the multiple first wireless devices, based on the first communication status data acquired for each of the first wireless devices.

(6)

The position estimation system of (3), wherein
the received signal strength included in the first communication status data is stored in the position estimation system in association with the time when the received signal strength is acquired.

(7)

The position estimation system of (6), wherein
if an amount of change of the received signal strength of the signal observed between the first wireless device and at least one second wireless device among the multiple second wireless devices is larger than or equal to a predetermined value, the second estimation process is selected.

(8)

The position estimation system of (6), wherein
if an interval of acquisition of the received signal strength of the signal observed between the first wireless device and at least one second wireless device among the multiple second wireless devices is larger than or equal to a predetermined value, the second estimation process is selected.

(9)

The position estimation system of (6), wherein
if the second wireless device connected to the first wireless device over the communication channel is changed, the second estimation process is selected.

(10)

The position estimation system of (6), wherein
if the number of second wireless devices having the received signal strength acquired in a state in which the first wireless device is at a predetermined position is smaller than a predetermined value, the second estimation process is selected.

(11)

The position estimation system of (6), wherein
the first wireless device is movable, and
the processor is configured to estimate, in the first and second estimation processes, the position of the first wireless device, using the received signal strength included in the first communication status data acquired after the first wireless device moves.

(12)

The position estimation system of (3), wherein
the processor is configured to estimate, in the first and second estimation processes, the position of the first wireless device, using a transmitted signal strength of a signal transmitted from the first wireless device, and
the transmitted signal strength is acquired based on information on a type of the first wireless device.

(13)

The position estimation system of one of (1) to (12), wherein
the processor is configured to estimate, in the first and second estimation processes, the position of the first wireless device based on a frequency band of the channel.

(14)

The position estimation system of one of (1) to (13), wherein
if multiple antennas are built in each of the multiple second wireless devices, the processor is configured to acquire the first communication status data for each of the antennas.

(15)

The position estimation system of one of (1) to (14), wherein
the processor is configured to estimate, in the first and second estimation processes, the position of the first wireless device, using a transmitted signal strength of a signal transmitted from each of the multiple second wireless devices.

(16)

The position estimation system of (3), wherein
each of the multiple second wireless devices is configured to instruct the first wireless device to scan the signal and acquire a received signal strength of a signal from the first wireless device as the scanning result, and
the processor is configured to acquire the received signal strength from each of the multiple second wireless devices.

(17)

The position estimation system of one of (1) to (16), wherein
the trained model is built to output fourth communication status data on a communication status between the first wireless device and each of the multiple second wireless devices by inputting third communication status data on a communication status between the first wireless device and at least some of the multiple second wireless devices, by learning from training data including the second communication status data.

(18)

The position estimation system of one of (1) to (16), wherein
the trained model is built to output the position of the first wireless device by inputting third communication status data on a communication status between the first wireless device and at least some of the multiple second wireless devices, by learning from training data including the second communication status data and a result of the first estimation process using the second communication status data.

(19)

The position estimation system of one of (1) to (18), wherein
the processor is configured to estimate, in the first and second estimation processes, the position of the first wireless device, using a position of the second wireless device acquired from each of the multiple second wireless devices.

(20)

The position estimation system of one of (1) to (18), wherein
the processor is configured to estimate, in the first and second estimation processes, the position of the first wireless device, using the position of each of the multiple second wireless devices held in advance.

(21)

The position estimation system of one of (1) to (18), wherein
the processor is configured to estimate, in the first and second estimation processes, the position of the first wireless device, using a position of each of the multiple second wireless devices, which is estimated based on fifth communication status data indicating a communication status among the multiple second wireless devices.

(22)

The position estimation system of (3), wherein
the processor is configured to estimate, in the first estimation process, the position of the first wireless device by applying the received signal strength included in the acquired first communication status data to a calculation formula on radio wave propagation.

What is claimed is:

1. A position estimation system comprising a processor configured to:
acquire first communication status data related to a communication status between a first wireless device and each of multiple second wireless devices;
perform a first estimation process to estimate a position of the first wireless device using the acquired first communication status data; and
perform a second estimation process to estimate the position of the first wireless device using an output of a trained model when the acquired first communication status data is input to the trained model, wherein
the first communication status data is acquired at different intervals depending on a channel connecting the first wireless device with each of the multiple second wireless devices,
the first estimation process or the second estimation process is selected based on the first communication status data, and
the trained model is built by using the training data that includes second communication status data related to the communication status between the first wireless device and each of the multiple second wireless devices in a state in which the first wireless device is at a predetermined position.

2. The position estimation system of claim 1, wherein
the first communication status data related to the communication status between the first wireless device and one of the multiple second wireless devices is measured at a short interval using a communication channel for executing wireless communication with the first wireless device, and
the first communication status data related to the communication status between the first wireless device and the other of the multiple second wireless devices is measured at a long interval using an observation channel different from the communication channel.

3. The position estimation system of claim 2, wherein
the first and second communication status data includes a received signal strength of the signal observed between the first wireless device and each of the multiple base stations.

4. The position estimation system of claim 3, wherein
the first wireless device includes a terminal device used by a user, and
the second wireless device includes a base station.

5. The position estimation system of claim 1, wherein the processor is configured to:
when multiple first wireless devices move, acquire, in the first and second estimation processes, the first communication status data for each of the first wireless devices, and
estimate a position of each of the multiple first wireless devices, based on the first communication status data acquired for each of the first wireless devices.

6. The position estimation system of claim 3, wherein
the received signal strength included in the first communication status data is stored in the position estimation system in association with the time when the received signal strength is acquired.

7. The position estimation system of claim 6, wherein
if an amount of change of the received signal strength of the signal observed between the first wireless device and at least one second wireless device among the multiple second wireless devices is larger than or equal to a predetermined value, the second estimation process is selected.

8. The position estimation system of claim 6, wherein
if an interval of acquisition of the received signal strength of the signal observed between the first wireless device and at least one second wireless device among the multiple second wireless devices is larger than or equal to a predetermined value, the second estimation process is selected.

9. The position estimation system of claim 6, wherein
if the second wireless device connected to the first wireless device over the communication channel is changed, the second estimation process is selected.

10. The position estimation system of claim 6, wherein
if the number of second wireless devices having the received signal strength acquired in a state in which the first wireless device is at a predetermined position is smaller than a predetermined value, the second estimation process is selected.

11. The position estimation system of claim 6, wherein
the first wireless device is movable, and
the processor is configured to estimate, in the first and second estimation processes, the position of the first wireless device, using the received signal strength included in the first communication status data acquired after the first wireless device moves.

12. The position estimation system of claim 3, wherein
the processor is configured to estimate, in the first and second estimation processes, the position of the first wireless device, using a transmitted signal strength of a signal transmitted from the first wireless device, and
the transmitted signal strength is acquired based on information on a type of the first wireless device.

13. The position estimation system of claim 1, wherein
the processor is configured to estimate, in the first and second estimation processes, the position of the first wireless device based on a frequency band of the channel.

14. The position estimation system of claim 1, wherein
if multiple antennas are built in each of the multiple second wireless devices, the processor is configured to acquire the first communication status data for each of the antennas.

15. The position estimation system of claim 1, wherein
the processor is configured to estimate, in the first and second estimation processes, the position of the first wireless device, using a transmitted signal strength of a signal transmitted from each of the multiple second wireless devices.

16. The position estimation system of claim 3, wherein
each of the multiple second wireless devices is configured to instruct the first wireless device to scan the signal and acquire a received signal strength of a signal from the first wireless device as the scanning result, and
the processor is configured to acquire the received signal strength from each of the multiple second wireless devices.

17. The position estimation system of claim 1, wherein
the trained model is built to output fourth communication status data on a communication status between the first wireless device and each of the multiple second wireless devices by inputting third communication status data on a communication status between the first wireless device and at least some of the multiple second wireless devices, by learning from training data including the second communication status data.

18. The position estimation system of claim 1, wherein
the trained model is built to output the position of the first wireless device by inputting third communication status data on a communication status between the first wireless device and at least some of the multiple second wireless devices, by learning from training data including the second communication status data and a result of the first estimation process using the second communication status data.

19. The position estimation system of claim 1, wherein
the processor is configured to estimate, in the first and second estimation processes, the position of the first wireless device, using a position of the second wireless device acquired from each of the multiple second wireless devices.

20. The position estimation system of claim 1, wherein
the processor is configured to estimate, in the first and second estimation processes, the position of the first wireless device, using the position of each of the multiple second wireless devices held in advance.

21. The position estimation system of claim 1, wherein
the processor is configured to estimate, in the first and second estimation processes, the position of the first wireless device, using a position of each of the multiple second wireless devices, which is estimated based on fifth communication status data indicating a communication status among the multiple second wireless devices.

22. The position estimation system of claim 3, wherein
the processor is configured to estimate, in the first estimation process, the position of the first wireless device by applying the received signal strength included in the acquired first communication status data to a calculation formula on radio wave propagation.
